(19) United States
(12) Patent Application Publication
(10) Pub. No.: US 2026/0162032 A1
(43) Pub. Date: Jun. 11, 2026

(54) COMPUTER-IMPLEMENTED STAFFING SCHEDULE EVALUATION METHOD AND SYSTEM FOR A RESOURCE ALLOCATION SYSTEM

(71) Applicant: THE WINGO RATIO LLC, Lutz, FL (US)

(72) Inventors: Robert Lee Wingo, Sugar Land, TX (US); Lisa Gubbels Wingo, Sugar Land, TX (US); Christopher Ogboke, Lutz, FL (US)

(21) Appl. No.: 18/973,009

(22) Filed: Dec. 8, 2024

(51) Int. Cl. G06Q 10/0631

(52) U.S. Cl. CPC G06Q 10/063116

(57) ABSTRACT

A staffing schedule evaluation method performed in a resource allocation system. The method includes collecting scheduled staff data and including the volume of staff scheduled to deliver a core business activity and the volume of staff not delivering the core business activity. Position data representing a total volume of staff potentially available to deliver the core business activity, is collected, together with a subset of the total volume that represents staff not actually available to deliver said core business activity, and Budget data representing a required volume of staff to deliver the core business activity. An Available Replacement data set is calculated using the Position data and the Budget data, and used to determine Capacity Gap. A Performance Ratio representative of a relationship between the Capacity Gap and the Budget data and/or Position data is calculated and compared with a predetermined value or threshold.

### FIELD OF THE INVENTION

This invention relates generally to a computer-implemented resource allocation method and system for staffing and scheduling, particularly, but not necessarily exclusively, for use within large service organisations such as healthcare facilities.

### BACKGROUND OF THE INVENTION

Large organisations, such as healthcare facilities, rely heavily on adequate staffing and scheduling in order to ensure a particular level of end user service provision. However, managing staffing and scheduling in organisations of this type is a complex task in that it must balance end user service needs, staff availability, and budget constraints. Understaffing can lead to a compromised end user service provision, an increased workload for staff on duty, and/or increase in labor costs due to using overtime and/or contract labor to address a staffing shortfall. Conversely, overstaffing results in unnecessary staffing costs for the organisation.

Methods and systems exist that attempt to manage and optimize staffing and scheduling. However, conventional such methods tend to focus only on job and productivity metrics to allocate resources for this purpose. However, these metrics are just performance metrics, which form only one part of effective workforce resource allocation, and, therefore, such methods often fail to adequately meet the staffing and scheduling needs of an organisation, as they do not take into account all of the other factors and metrics relevant to effective workforce resource allocation, thus resulting in inadequate staffing and scheduling, which, in turn, has a negative impact on productivity and staff costs. Such methods and systems not only fail to take into account all of the data relevant to workforce allocation, but they also fail to granularize the data they do utilize to a sufficient extent, such that key data affecting staffing and scheduling is disregarded. Conventional staffing and scheduling methods and systems are thus not capable of processing and effectively utilizing all of the data points that have an impact on staffing and scheduling, and the optimization techniques they utilize would be incapable of handling a problem of the size that that would result with the inclusion of all such data points.

Thus, it is an object of this invention to address at least one or more of these issues, utilizing, combining and processing multiple relevant metrics in a unique manner, and providing a unique optimization module, so as to provide an improved resource allocation method and system for staffing and scheduling.

### SUMMARY OF THE INVENTION

According to an aspect of the invention, there is provided a computer-implemented staffing schedule evaluation method performed in a resource allocation system comprising, or communicably coupled to, a Staffing and Scheduling module and/or a Time and Attendance module, a Budget Module and a Position Control module, the method comprising, under control of a processor of said resource allocation system:
collecting, from a said Staffing and Scheduling module and/or a Time and Attendance module, scheduled staff data representative of a specified staffing schedule covering a specified period of time and including Direct staff data representative of the volume of staff scheduled, in said specified staffing schedule, to deliver a core business activity and Inactive staff data representative of the volume of staff included in said specified staffing schedule as not delivering said core business activity;
transforming said Inactive staff data from said scheduled staff data into a normalized Actual Replacement data set representative of said Inactive staff data;
collecting, from a said Position control module, Position data representative of a total volume of staff potentially available, during said specified period of time, to deliver said core business activity, and a subset of said total volume representative of staff not actually available, during said specified period of time, to deliver said core business activity;
collecting, from a said Budget module, Budget data representative of a required volume of staff to deliver said core business activity to a specified service level for a given volume of core business activity;
transforming said Position data and said Budget data into respective normalized data sets;
calculating an Available Replacement data set using said Position data and said Budget data;
determining, using said Actual Replacement data set and said Available Replacement data set, Capacity Gap data;
determining a Performance Ratio representative of a relationship between said Capacity Gap data and said Budget data and/or said Position data; and
comparing said Performance Ratio with a predetermined value or threshold to generate evaluation data in respect of said specified staffing schedule.

The Inactive staff data may comprise two or more subcategories, including Indirect hours, representative of hours scheduled for work but not contributing to the core business activity (e.g. training, orientation, etc.) and Nonproductive hours, representative of hours, paid or unpaid but not worked (e.g. sick leave, vacation, etc.). Indeed, in an embodiment, the Staff data and/or the Position data representative of staff not actually available, during said specified period of time, to deliver said core business activity may comprise two or more subcategories indicative of a cause of a lack of availability of said staff. Such subcategories may include Indirect hours representative of hours scheduled for work not contributing to said core business activity (e.g. training, orientation, etc) and Nonproductive hours representative of hours, paid or unpaid but not worked (e.g. sick leave, vacation, etc.). In some embodiments, the Indirect hours data and the Nonproductive hours data may each be subdivided into further subcategories to provide deeper assessments and insights into staffing and scheduling operations. In addition, Direct hours Position data, representative of a total volume of staff potentially available, during said specified period of time, to deliver said core business activity, may also be subdivided into subcategories to represent, for example, specified skill sets or skill levels of said available staff.

The method may further comprise displaying, on a user interface, scheduling data comprising said Budget data, said Position data, said Available Replacement data, said scheduled staff data, and said Performance Ratio.

In an embodiment, the method may further comprise allowing a user, via the user interface, to alter one or more of the Budget data, the scheduled staff data and the Position data. And recalculate the Performance Ratio using the altered data.

The method may further comprise generating a float hours matrix representative of a normalized data set of staff hours floated from one team to another.

In an embodiment, the method may further comprise generating optimized Budget data by:
receiving, from a user, a staffing metric representative of a desired level of end user service;
receiving weighted Unit of Service data representative of a volume of end users required to receive said level of end users; and
calculating, using said staffing metric and weighted Unit of Service data, Direct staff data representative of a volume of staff required to deliver said desired level of end user service.

In a resource allocation system incorporating a said Position Control module, the method may include:
receiving, in said Position Control module, Position Control data representative of position statuses, job statuses, job status change dates and expected or actual Direct, Indirect and Nonproductive time distribution for each filled position; and
calculating, in near real-time or real-time, staffing capacity data using said Position control data.

Additional Position Control fields may be provided for reporting to certification and regulatory bodies. Such additional fields may, for example, comprise degrees and types of degrees, years of experience, professional certifications, etc.

Optionally, the method may further comprise:
obtaining Budget data from a said Budget module and/or obtaining Census data from said Staffing and Scheduling module or other external system (such as an electronic medical record); and
calculating Actual Replacement data and/or Capacity Gap data utilizing said Position Control data, said Budget data, and/or said Census data.

According to another aspect of the invention, there is provided a computer-implemented staffing schedule evaluation system for a resource allocation system, the staffing schedule evaluation system comprising a processor and a memory and being configured, under control of the processor, to execute instructions stored in the memory to perform the method substantially as described above.

These and other aspects of the invention will be apparent from the following detailed description.

### BRIEF DESCRIPTION OF THE DRAWINGS

An embodiment of the present invention will now be described, by way of example only, and with reference to the accompanying drawings, in which:

FIG. 1 is an illustration of the interrelated mathematical and informational layers to describe budgeting, scheduling and staffing processes that impact effective resource allocation;

FIG. 2 is a schematic block diagram illustrating key modules included in a resource allocation system, and key data flows in a resource allocation method, according to an exemplary embodiment of the present invention;

FIG. 3 is a schematic block diagram illustrating key modules included in a resource allocation system, and key data flows in a resource allocation method, according to an exemplary embodiment of the present invention, illustrating the data provided by each of the modules for use by the system and/or in the method;

FIG. 4 is a table illustrating fictional Position Control data used in a method or system according to an exemplary embodiment of the invention;

FIG. 5 is a table illustrating fictional Time and Attendance data used in a method or system according to an exemplary embodiment of the invention;

FIG. 6 is a table containing fictional data and illustrating one part of Capacity Gap analysis;

FIG. 7 is a table containing fictional data and illustrating a subsequent part Capacity Gap analysis; and

FIG. 8 is a table containing fictional data and illustrating the used in, and analysed by, an optimization function for use in a resource allocation method or system according to an exemplary embodiment of the invention.

### DETAILED DESCRIPTION OF THE INVENTION

In the following description of various exemplary embodiments of the invention, reference is made to the accompanying drawings that form a part hereof, and in which are shown, by way of examples and illustration, specific embodiments in which the invention may be practiced. These embodiments are described in sufficient detail to enable those skilled in the art to practice the invention, and it is to be understood that other embodiments may be utilized and that variations and modifications may be made, without departing from the scope of the invention as defined in the appended claims. The following detailed description is therefore not to be taken in a limited sense.

The specification may refer to “an”, “one” or “some” embodiment(s) in some parts. This does not necessarily imply that each such reference is to the same embodiment(s), or that the feature applies to only one embodiment. Single features of different embodiments may also be combined to make another embodiment.

As used herein, the singular forms “a”, “an” and “the” are intended to include the plural forms as well, unless expressly stated otherwise. It will be further understood that the terms “includes”, “comprises”, “including” and/or “comprising”, when used in this specification, specify the presence of stated features, integers, steps, operations, elements and/or components, but do not preclude the presence or addition of one or more other features, integers, operations, steps, elements, components and/or groups thereof As used herein, the term “and/or” includes any and all combinations and arrangements of one or more of the associated listed items.

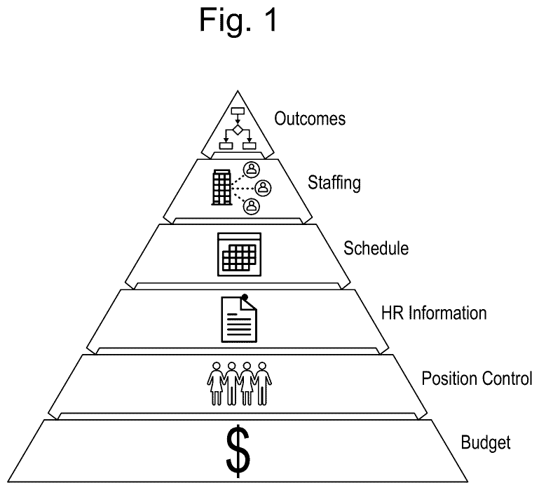

Interrelated mathematical and informational layers can be used to describe the budgeting, scheduling and staffing processes that impact effective resource allocation in staffing and scheduling. Referring to FIG. 1 of the drawings, these layers can be considered theoretically in the form of a multi-layered pyramid, with layers representing Budget, Position Control, HR Information, Schedule, Staffing, Timekeeping/Payroll, and Outcomes. Moving from bottom to top in the illustrated model, the Budget layer (at the bottom) is the foundational element, and it determines the total resources required to provide the desired end user service level for an expected volume of such end users, thereby establishing the framework for the rest of the model.

In the following example, the metric ‘FTE’ (or Full Time Equivalent) is a (known) critical metric in workforce management that expresses total workload of staff in full time positions. It is used to measure the full time staff members that an organisation's workforce (or a sub-set thereof) represents. FTE is an aggregator of hours and is a measurement that combines the hours of part-time and full-time employees to determine how many full-time employees would be needed to perform those hours. Thus, FTEs are used to standardize headcount, and can help businesses to make more accurate budgets and strategic decisions. In an exemplary embodiment of the invention, it is a standardized way to quantify staff resources, considering both full-time and part-time staff, and allows for efficient comparison and optimisation of staffing levels across different departments and shifts.

Referring back to FIG. 1, in the illustrated model, the Position Control layer subdivides the FTE totals into individual positions, and filled positions in the Position Control layer populate the Schedule layer. The HR Information layer is a crucial informational layer that significantly influences decisions in the Schedule and Staffing layers: factors such as licensure, certification, special training, experience and language skills, for example, can all influence assignments in the Staffing and Schedule layers. In this model, in the Schedule layer, staff members can be assigned one of two states: independently participating in end user service provision (direct time) and not independently participating in end user service provision. Staff members independently participating in end user service provision become the primary input for end user service provision in the Staffing layer. The Staffing layer may be adjusted according to available resources, volume of core business to be provided, and other operational factors.

The delivery of the end user service through the Staffing layer heavily influences the Outcomes layer, which may incorporate a variety of quality, safety, productivity and financial metrics (for qualifying and quantifying the Outcomes), depending on the nature of the organisation. The allocation and assignment of staff in the Staffing layer influences the Timekeeping/Payroll layer. The timekeeping system captures and categorizes time to be passed to the Payroll system for payment. The time categorization may be used to calculate payment for such things as shift differential, on-call pay, back pay, over time, double time, missed meal breaks, etc. The distribution and allocation of resources in the Staffing layer determines where the employees' time should be captured by the time and attendance system, as well as the category and modifiers such as shift differential, etc. listed above. This information is then passed to the payroll system for processing. This heavily influences the financial outcomes.

Aspects of the invention take into account that resource variances in one layer of the illustrated model can have ripple effects throughout the other layers, and impact the Outcomes layer, so as to provide an improved method and system for resource allocation for use in staffing and scheduling within an organisation, such as a healthcare facility. In the following, description, reference is made to a method and system for resource (i.e. nurse) allocation for staffing and scheduling in a healthcare facility. The nurse staffing problem pertains to the challenge faced by healthcare facilities such as hospitals, clinics and nursing home, in efficiently managing and optimizing their nursing staff to provide the desired levels of care for a given volume of patients. In the described example, there is introduced a novel data-driven approach to address the nurse staffing problem, which seeks to enhance patient care, staff satisfaction and overall operational efficiency. The proposed dynamic nurse staffing optimization solution seeks to provide unprecedented visibility of operational factors which impact staffing, scheduling, productivity and labour costs by striking a delicate balance between hard constraints which must be met to ensure compliance and efficient operation, and soft constraints which are designed to maximise employee satisfaction, patient care, and overall organisational productivity, as well as cost controls. These novel tools and methodologies can be integrated into new and existing systems, or developed as stand-alone applications.

However, it is to be understood that the present invention is not necessarily limited to this use case, and the same technical concepts and principles can equally be applied to staffing and scheduling in other types of organisation.

A component of the proposed solution includes Optimization and PRN Requests: The system operates dynamically, continuously assessing staffing needs based on both real-time and predictive data. It allows for adjustments to the PRN position requests as the week progresses, ensuring staffing levels are continuously optimized to meet patient needs. When a skill level or skill coverage gap is identified in the upcoming week's schedule, the system alerts the staffer/scheduler of the shortfall. The solution provides the staffer/scheduler with the option to request PRN (as-needed) positions to fill these gaps temporarily. The optimization system considers current staffing levels as well as predictive needs. It searches for a staffing solution that preemptively proposes feasible staffing adjustments that optimize multiple objectives.

### Data Collection, Analysis and the Use of Predictive Models

The proposed method and system uses business-centric modelling (e.g. care-centric modelling in the case of nursing). Business-centric modelling provides a resource allocation model that considers, in relation to the filled FTEs (i.e. the FTEs that are filled, as opposed to vacant, positions), the resources required for direct time (i.e. time spent delivering the end user service), those who are new and, therefore, not yet able to independently participate in delivering the end user service, those on leave, and other scenarios that prevent employees from independently participating in end user service provision, to determine the number of hours each week (say) that can be utilized for indirect and non-productive shifts when creating future schedules, while reserving the resources needed for direct time for core business activities (i.e. in this example, patient care).

In this example, an FTE-based workforce management solution is proposed, that incorporates scheduling requirements and addresses skill level and skill coverage gaps, with the ability to request PRN positions as needed. The model aims to efficiently allocate staff by considering all portions of an FTE and various constraints and objectives, such as skill level coverage, skill coverage, budget constraints, personal preferences, consistency and flexibility. In contrast, conventional nurse scheduling processes often fail to account for all aspects of the FTE and scheduling complexities, thereby potentially compromising patient care, employee satisfaction, and end user service delivery.

In the following example, the FTE hours in the Budget, Staffing, Scheduling and Timekeeping/Payroll layers are classified into three broad categories to facilitate data analysis:
Direct Time: Time worked by employees independently participating in patient care that should count towards productivity calculations.
Indirect Time: Time worked by employees that support patient care operations but should not count in productivity calculations. Examples of indirect time may include orientation, education, administrative tasks, attending conferences, staff meetings, etc.
Non-Productive Time: Typically, the employee is not working but is paid from their benefit time for things such as sick, vacation, and holiday time. While it's unpaid, Leave Without Pay is included in this category.

The delivery of patient care through the Staffing layer heavily influences the Timekeeping/Payroll and Outcomes layers, which include patient outcomes and a variety of quality, safety, productivity, and financial metrics.

As described above, resource variances in one layer can have ripple effects throughout the other layers and impact the outcomes layer.

The proposed solution utilizes the Full-Time Equivalent (FTE) as the primary unit of measurement for nurse staffing. FTE is an aggregator of hours, which allows for easy conversions between FTEs, shifts, and hours. This approach provides a standardized way to quantify nursing resources, considering both full-time and part-time staff, and allows for efficient comparison and optimization of staffing levels across different departments and shifts.

This exemplary embodiment provides an innovative staffing and workforce management approach that utilizes Full-Time Equivalent (FTE) as the fundamental unit of measurement. It addresses the complexities of staffing and scheduling by incorporating scheduling requirements, skill level coverage, and skill coverage considerations while providing data and feedback for Operations, Human Resources, and Finance that offers unprecedented visibility into factors affecting staffing, scheduling, productivity, and labor costs.

When skill level or skill coverage gaps are identified within a department, the solution offers a dynamic process to request PRN (as-needed) positions to fill these gaps for the upcoming week, optimizing staffing and enhancing outcomes, such as patient care in the nursing setting.

Business-centric modelling requires three data sets:
1. Filled FTEs, by skill (i.e. staff members making up the full quota of FTEs within the workforce or team, including data representative of their skillset).
2. Budgeted Direct Time FTEs, by skill, required to deliver the core business service provision (e.g. patient care).
3. The status of the staff members in the FTEs referenced in 1. above, such as ‘orientation’ (i.e. they are very new and unable to work independently yet), leave, or any other status that would prevent the staff member from independently participating in direct time (i.e. delivery of the core business service provision).

The model can then utilize these data sets to calculate a metric referred to herein as ‘Available Replacement FTEs’. In nursing budgets, ‘Replacement’ refers to the costs and resources associated with covering shifts when regular nursing staff are unavailable, for reasons such as sick leave, vacation, personal time off, education and training, etc. The formula utilized (for a nursing example) is:

$$Filled FTEs - Patient Care FTEs - ‘ Orientation ’ FTEs - Leave \& Other FTEs = Available Replacement FTEs$$

Multiplying this result by (say) 40 hours per week determines how many resources can be allocated each week to non-patient care shifts when building schedules. It will be appreciated that, since there will be a finite (and defined) number of FTEs available, scheduling more than (Available Replacement FTEs×40) hours for non-patient care shifts will result in taking resources from patient care and, therefore, a negative impact on patient care (the end user service provision), and/or a negative impact on finance (because relief staff and/or overtime must be paid), and/or a negative impact on nurse satisfaction (because those left to provide the patient care are over-worked).

This can be demonstrated as follows:

TABLE 1

| | | | | | | | | | | | | | | | | Net |
|---|---|---|---|---|---|---|---|---|---|---|---|---|---|---|---|---|
| | | | | | | | | | | | | | Avail- | | Net | avail- |
| | | | | | | | | | | | | Avail- | able | | avail- | able |
| | | | | | | | | | | | | able | replace- | Av. | able | replace- |
| | Bud- | | | | | Patient | | Orien- | | Leave + | | replace- | ment | Weekly | replace- | ment |
| sce- | geted | Vacant | Vacancy | Filled | | care | | tation | | other | | ment | hours/ | call-in | ment | 12-hr |
| nario | FTEs | FTEs | rate | FTEs | − | FTEs | − | FTEs | − | FTEs | = | FTEs | week | hrs | hours/wk | shifts/wk |
| 1 | 30.0 | 0.00 | 0.0% | 30.0 | | 25.5 | | 0.00 | | 0.00 | | 4.50 | 180 | 0 | 180 | 15 |
| 2 | 30.0 | 2.25 | 7.5% | 27.5 | | 25.5 | | 0.00 | | 0.00 | | 2.25 | 90 | 84 | 6 | 0.5 |
| 3 | 30.0 | 3.00 | 10.0% | 27.0 | | 25.5 | | 0.00 | | 0.00 | | 1.50 | 60 | 84 | −24 | −2 |
| 4 | 30.0 | 3.00 | 10.0% | 27.0 | | 25.5 | | 2.70 | | 0.90 | | −2.10 | −84 | 84 | −168 | −14 |
| 5 | 30.0 | 4.75 | 15.7% | 25.29 | | 25.5 | | 1.80 | | 0.90 | | −2.91 | −116.4 | 0 | −116.4 | −9.7 |
| | | | | Filled | − | Patient | − | Orien- | − | Leave + | = | Avail- | | | | |
| | | | | FTEs | | care | | tation | | other | | able | | | | |
| | | | | | | FTEs | | FTEs | | FTEs | | replace- | | | | |
| | | | | | | | | | | | | ment | | | | |
| | | | | | | | | | | | | FTEs | | | | |

In the above examples, the budgeted FTEs in column 1 (i.e. the total number of FTEs budgeted to cover the end user service provision and those allocated to non-patient care shifts) remains constant, at 30, for all five illustrated scenarios.

In scenario 1, all of those budgeted FTE positions are filled and the vacancy rate is at a very unrealistic rate of 0%. 25.50 FTEs are required to deliver the desired/required level of end user service (e.g. patient care), and (again, somewhat unrealistically) nobody is on ‘orientation’, leave or otherwise prevented in some way from independently participating in direct time.

In this case, and using the above-referenced equation:

$$Actual Replacement FTEs = 30 - 25.5 - 0 - 0 = 4.5$$

When multiplied by 40 (hours), there would be 180 available replacement hours, which can also be represented as 15 12-hour shifts, per week that could be allocated to non-patient care shifts, whilst leaving the required 25.50 FTEs needed to provide the desired level of patient care. These replacement hours can then be allocated to allow for time off, education and training, etc.

Scenario 1 is, however, highly unrealistic, particularly in the field of healthcare, and there is little likelihood that all budgeted FTE positions would be filled. It is also highly unlikely, in any given week, that all of the filled FTEs would be available to independently participate in direct time. In reality, nursing units rarely have all budgeted FTEs filled.

Thus, in Scenario 2, a 7.5% vacancy rate has been introduced, leaving 27.75 filled FTEs. The patient care FTEs remain the same, of course, and, once again, none of the filled FTEs are unavailable to participate in direct time. It can be seen that, even at this very modest vacancy rate, the available replacement hours each week has halved, to 90 or 7.5 12-hour shifts.

In scenario 3, the vacancy rate has changed to 10%, which brings the available replacement hours down further, to 60, which is just 5 12-hour shifts. However, once again, rather unrealistically, none of the filled FTEs is unavailable for independent participation in direct time.

Accordingly, in Scenario 4, whilst the vacancy rate remains at 10%, now, 2.70 FTEs on ‘orientation’ and 0.9 FTEs otherwise unavailable for independent participation in direct time have been introduced. In this case, there is a shortfall of one 12-hour shift daily, that will have to be filled (at additional cost) with overtime or relief workers, for example, if the desired level of patient care is to be delivered, or left unfilled, which will have a negative impact on patient care and/or nurse satisfaction.

In scenario 5, using a yet more realistic vacancy rate of 15.7% (according to recent figures), the filled FTEs are reduced to 25.29, which is lower than the FTEs required to deliver patient care at the expected budgeted census, even before we add in 1.80 FTEs on orientation and 0.9 FTEs otherwise unavailable for independent participation in direct time. This results in a shortfall of two 12-hour shifts daily per week, further compounding the problems referenced above. The addition of orientation and leave FTEs in this scenario can significantly increase the need for expensive labour to meet operational needs.

The scenarios described above use only known data, but the system can be configured to utilize historical operational data to inform statistical probability of needs arising that would require immediate staffing adjustments because, for example, people have called in at the last minute to say they cannot work due to sickness or other unforeseen issue.

This is represented by the three columns on the far right of the above table. Scenario 1 sets call-in hours unrealistically at 0, leaving the predicted net available replacement hours per week unchanged, and giving fifteen available replacement 12-hour shifts per week. In scenarios 2, 3 and 4, the call-in hours column has been set to 84 (the equivalent of one 12-hour shift per day becoming unavailable at short notice). In scenario 2, this leaves just half of a 12-hour shift per week as the net available replacement, whereas in scenarios 3 and 4, it can be seen that the net available replacement becomes negative (or more negative), resulting in a shortfall (or greater shortfall) in FTEs expected to be available for independent participation in direct time, that will either have to be made up in some way (at a cost) or left unfilled, to the detriment of patient care and nurse satisfaction.

In scenario 5, even though the call-in hours are set to 0 (so the calculations remain unchanged), it can be seen from the column on the far right that there is a shortfall of 9.7 12-hour shifts per week, without even allowing for the that someone (or even multiple staff members) could call in at the last minute to say they are unable to work.

Going back to the model illustrated in FIG. 1 of the drawings, it can be seen that negative issues arising in relation to patient care could, therefore, lie in the Staffing layer, because patient volume was higher than expected, for example, or in the Schedule layer (in that resources were inadequately allocated in the first place). Equally, the problem could lie in the Position Control layer (in that the vacancy rate is too high and there are too many unfilled FTEs) or in the Budget layer, for example, if the healthcare facility uses the flawed conventional nursing budget process, or if patient volume is significantly underestimated. The impact of decisions/mistakes made at the Budget and Position Control layers will flow through the Schedule and Staffing layers and impact the Timekeeping/Payroll and Outcomes layers. Aspects of the invention enable evidence-based management in staffing and scheduling operations and can link executive leaders' financial and resource decisions to staffing capacity and end user service delivery layers.

Using the above-described models, aspects of the invention provide an innovative resource allocation system and method for staffing and scheduling, utilizing enhanced algorithms and optimization techniques, as well as unique data transformations, to monitor and/or analyze the effectiveness of staffing schedules, and to continuously assess staffing needs, based on both real-time and predictive data, allowing for adjustments to PRN position requests as a week progresses, and ensuring staffing levels are continuously optimized to meet (e.g.) patient care needs. It considers current staffing levels and predictive needs, and can search for a staffing solution that pre-emptively proposes feasible staffing adjustments that can optimize one or multiple objectives (depending on user- and/or organization-adjustable variables and constraints).

The approach ensures a mathematically transparent optimization process, facilitating the creation of well-balanced schedules.

While the innovative approaches outlined in this patent application have many potential applications, enhancements to a few key inputs are crucial and lead to a new metric for assessing the effectiveness of available resource allocation.

Beginning with the foundational layer of the Staffing Information Structure, an Enhanced Budget Tool includes interactive settings to account for all portions of each FTE to ensure optimal resource allocation across all segments of time each FTE will utilize. In this way, each department can be assured of adequate FTEs to cover its expected volume.

Next, an Enhanced Position Control includes additional data elements that provide a complete picture of each employee's ability to participate in Direct time while providing an understanding of the Indirect and Non-productive portions of their FTE.

Moving up to the Schedule layer, Enhanced Scheduling and Staffing Views leverage inputs from the Enhanced Budget Tool, Position Control, and the resulting new metric gives critical information regarding how well resources have been allocated to support the Budget given the state of the Position Control.

These additions can then be rolled up to provide insights for the Department and further rolled up to the Facility across departments or health systems.

As well as FTEs, additional types of data and data set that are employed in this exemplary embodiment of the invention, that further provide accurate depictions of the feasibility of the current staffing level, are:

### Budget Tool

In a system according to an exemplary embodiment of the invention, a Budget Tool incorporates some of the previously outlined concepts to provide insight to operations, HR, and finance leaders on how budgets transform into care at the bedside in nursing. It also calculates the number of support/ancillary staff needed to support unit operations.
Staffing Metric/Target: Worked Hours Per Unit of Service (WHPUOS), or for nursing, it could also be Nurse: Patient Ratio, Nursing Hours Per Patient Day (NHPPD), visits, procedures, etc.
   Sets desired level of care. For example, a nurse: patient ratio (UOS) of 4 and a census (Volume) of 20 would require 5 nurses.
Units of Service (UOS): Patient Volume: relative value units (RVUs), or Census, visits, procedures, etc.
   Sets the volume for the desired level of care.
   Recommended to evaluate the average UOS volume by at least the day of the week to account for day-to-day volume variances.
   Evaluating budget needs for patient volume can be calculated for any timeframe between hourly and daily if intraday volume fluctuates significantly.
A skill or job, such as RN, LPN, nursing assistant, unit secretary, etc., must be defined in simple terms that can be easily aggregated. Jobs not participating in patient care may be included in total Worked Hours Per Unit of Service (WHPUOS) calculations.
Weighting/classification levels for the staffing metric
   Weighting: Procedure A may require only 1 staff member and take 15 minutes to complete, while Procedure B may require 2 staff members and take 45 minutes to complete.
   Classification Levels: A unit may have a mixture of patients with different acuity levels or required levels of care. If a unit has 12 patients who require a 1:4 nurse-to-patient ratio and 6 patients who require a 1:3 nurse-to-patient ratio, the hours required for each classification level can be calculated and then combined to determine the total FTEs/hours needed to care for those patients.
Direct Care FTEs for Core Staffing are calculated by determining the resources needed to care for a given volume of patients at a desired level of patient care.
Staffing Timeframe: Staffing needs (workload) can be calculated using different time periods, ranging from a week to daily, by shift, by 4-hour blocks, and even hourly. However, shorter time periods introduce operational challenges with finding and/or reallocating resources and the associated handoffs and assessments that need to be done.
Replacement Time
   After determining Direct Care FTEs, Replacement FTEs must be calculated to provide additional resources for coverage when an employee is scheduled in a non-patient care capacity. Replacement time should be calculated as the percentage of total FTE hours employees are expected not to be scheduled for patient care.
   If each employee is expected, on average, to spend 15% of their time in indirect and non-productive shifts, then Total FTEs should be calculated by Direct Care FTEs/(1−Replacement %) or, in this case, Direct Care FTEs/(1=0.15). The difference between Total FTEs and Direct Care FTEs is the Replacement FTEs.
Replacement Categories:
   Indirect Time is any time the employee is on the clock but working in a role that should not be counted in productivity. Common types of indirect time include orientation, education, administrative time, staff meetings, etc. Some facilities may exclude charge nurses, sitters, and other support staff from their productivity calculations. The system will allow users to configure the skills that should count in productivity calculations.
   Non-productive time is when the employee is not working but still getting paid. In order to capture hours and FTEs, instances where an employee is on leave without pay are also included.

### Position Control

Traditionally, Position Control focuses primarily on whether a position is filled or not. While it lists all positions, employees, and their FTEs, it offers limited feedback to leadership on whether the number of positions and staff aligns with their operational needs.

Basic position control fields:
Position ID
Position Requisition Number
Employee Name
Department Number
Departmental Position Number
Department Name
Job Code/Job ID
Job Title
FTE
FTE Type: Full Time, Part-Time, or Per Diem
Shift
Start Date

Adding a few key fields can significantly enhance the effectiveness and functionality of Position Control. Granularizing the data further enables the system to provide valuable workforce allocation information and produce data that can be further analyzed using care-centric modeling formulas:
Job:
   This is a simplified version of the Job Title. For example, there can be multiple Job Titles for RN position postings such as “RN-Med/Surg-New Grad”, “RN-Med/Surg-2 years experience required”, “RN-Med/Surg-Charge Nurse Experience”, etc. We must roll up the positions to simple categories for care-centric modeling and resource allocation analysis, such as RN, RNC, CNA, LPN, US, etc.
Position Status:
   Filled: The position is filled with an employee.
   Vacant: The position is vacant.
   Pending: Position has been approved, but not posted.
   Offered: The position is waiting on an acceptance of an offer or the employee has accepted the offer but has not been onboarded yet.
   Additional Position Statuses may be added to address specific operational reporting and data analysis needs.
Job Status
   Vacant: The position is vacant.
   Productive: The employee has completed orientation and is productive.
   Orientation: The employee is on orientation.
   LOA: The employee is on a leave of absence
   Other: Example: The employee has been temporarily reassigned to work in another unit, such as a COVID unit, but remains an employee of their home unit.
   Additional Job Statuses may be added to address specific operational reporting and data analysis needs.
Job Status Change Date
   Using a date-dependent field for Job Status allows us to monitor and track the status of the FTE and how it impacts staffing capacity.
   For example, by identifying when an employee is expected to complete orientation, we can assess the impact on our staffing capacity once the employee becomes fully productive.
   Conversely, if we know that three nurses will be starting maternity leave at approximately the same time, we can identify on Position Control when they will begin their leave and the impact it will have on staffing capacity.
Expected Direct, Indirect, and Non-Productive Time Distribution
   Individual employee rows can contain fields indicating the employee's expected distribution of FTE hours in the Direct, indirect, and Non-Productive categories. This information forms the basis for near-real-time staffing capacity data and allows for the calculation of expected replacement utilization.
   Individual employee indirect and non-productive time can be calculated and estimated based on known factors such as required or planned education and averaged data, such as how much vacation and sick time an employee typically uses.
   For example, a 12-week orientation for a 0.9 RN represents a 23.1% indirect time utilization for that employee. When combined with additional educational requirements and time off, it's possible that a new employee could approach a 30% replacement utilization during the year. Multiple employees on orientation that utilize 25-30% replacement for the year can significantly impact staffing capacity.
   Longer tenured employees may accrue benefit time at a higher rate than new employees. With more benefit time to use, the actual replacement utilization by these employees may be higher. Capturing/calculating this information by employee can provide a more accurate estimation of replacement resources needed.
   Time distribution information can be aggregated at the system, facility, unit, skill, shift, or employee level.
Actual Direct, Indirect, and Non-Productive Time Distribution
   By capturing actual direct, indirect, and non-productive time utilization from the staffing and scheduling or time and attendance system, the system can identify individual employees who are over or under-utilizing replacement time for additional workforce insights.
   Time distribution information can be aggregated at the system, facility, unit, skill, shift, or employee level.
   For example:
      If all employees are overutilizing indirect time, it may be due to an educational initiative, such as an EHR implementation, that was not considered for resource planning.
      If there is a high utilization of orientation for the day shift, it may make it more difficult to provide day shift employees with time off without negatively impacting the resources needed for patient care or incurring additional labour expenses due to overtime and contract labour.

The information above can feed the care-centric modeling calculation for Available Replacement time and FTEs, which assesses the budgeted resources available for Indirect shifts and Non-Productive time.

The information above feeds into the business-centric modeling calculation for Available Replacement time and FTEs, which assesses the budgeted resources available for Direct and Indirect shifts and Nonproductive time.

With the new Position Status, Job Status, and Job Status Date Change fields, we can calculate staffing capacity in near real-time by integrating with the Capacity Gap Analysis for Actual Replacement Utilization, the Budget Module for the desired level of care, and projected census. The date-dependent fields also allow for monitoring and modeling future staffing capacity and resource needs, as illustrated in the table below.

TABLE 2

| | | | | | | | | Available |
|---|---|---|---|---|---|---|---|---|
| FTEs from Budget | | | FTEs from Position Control | | | | | Replacement |
| Budgeted | Patient | Replacement | | Patient | | | | FTEs |
| FTEs | Care % | % | filled | care | Orientation | leave | other | AVR |
| 28.69 | 80% | 20% | 22.5 | 22.95 | 1.80 | 0.9 | 0.0 | −3.15 |

| FTEs from Time and Attendance | | | | | Actual | | | |
|---|---|---|---|---|---|---|---|---|
| (set date range below to calculate | | | | | Replacement | | | |
| Actual FTE by week for Ratio) | | | | | Utilization | | | |
| | | | In- | Non | FTEs | FTE | Gap | Performance |
| start | end | wks | direct | paid | ARU | Gap | filled | ratio |
| June | August | 6 | 1.91 | 1.87 | 3.78 | −6.80 | −0.31 | −120 |
| 2024 | 2024 | | | | | | | |

Table 2 above illustrates the Business-centric formula incorporated into Position Control Tool
   Budgeted FTEs
      Direct
      Indirect
      Non-Productive
   Filled FTEs
   Patient Care FTEs
   Available Replacement FTEs
      Positive Available Replacement FTEs represent the number of hours that can be scheduled each week for non-patient care shifts
      Negative Available Replacement FTEs indicate the shortage of resources needed to meet the desired level of patient care.
Calculation of Performance Ratio metric (to be described hereinafter)
Span of Control statistics

Performance Ratio Comparing budgeted resource allocation from position control with actual resource allocation from time and attendance or staffing and scheduling data enables us to identify staffing capacity gaps. It also lays the foundation for a new metric: the Performance Ratio.

This algorithm yields a ratio representing the staffing capacity for the specific skillset or skill level, considering the balance between Direct and Indirect/Non-productive allocation. For nursing, it is the balance between patient care and non-patient care responsibilities.

IF(ARU=0,“Null”,(IF(AVR=0,FTE Gap/Filled,IF(AVR=−1,AVR*ABS(FTE
Gap/Filled),IF(AND(ARU>AVR,AVR<0),ARU/AVR,AVR/ARU))))*100)

### Actual Replacement Utilization FTEs (ARU)

Obtained from Staffing and Scheduling or Time and Attendance data and are determined by aggregating all indirect and non-productive hours calculated as a percentage of total hours and converting the sum into FTEs, thereby effectively normalizing the ARU data into a suitable format for use in the above-referenced algorithm.
   When aggregating hours into FTEs, calculated based on (in this example) 1 week (40 hours)

### Available Replacement FTEs (AVR)

Obtained from the Budget and Position Control
Determine the total Full-Time Equivalent (FTE) staff available for the required skillset or skill level.
   Available (Filled) FTEs are obtained from Position Control.
Determine the Direct FTEs required to provide the desired level of work (in nursing, this will be patient care, considering only those FTEs that can independently participate in patient care).
   Direct (Patient Care) FTEs are obtained from the Budget
Calculate AVR by subtracting the Direct FTEs (from budget) from the Filled FTEs (from position control) and then subtract all indirect and nonproductive FTEs (from position control)
   Filled FTEs−Direct FTEs−Indirect FTEs (such as Orientation)−NonProductive FTEs (such as Leave)=Available Replacement FTEs (AVR)

### FTE Gap

Used by [Gap/Filled] in the Performance Ratio, the FTE Gap is calculated by subtracting Actual Replacement Utilization FTEs from Available Replacement FTEs
   AVR-ARU

### Gap/Filled.

Represents the FTE Gap as a percentage of available resources (Filled FTEs)
Calculated by dividing the FTE Gap by the Filled FTEs
   FTE Gap/Filled FTEs

### Gap/Budget

Represents the FTE Gap as a percentage of budgeted resources (Budgeted FTEs)
Calculated by dividing the FTE Gap by the Budgeted FTEs
   FTE Gap/Budgeted FTEs

In this staffing optimization model, as illustrated in the table below, the “health” or capacity of the staffing for a particular skill set or skill level of employee class is a critical metric to consider. This measurement helps assess the ability of the staffing solution to handle normal variations, such as sick calls, leaves, holidays, and non-direct duties, such as educational/training requirements while maintaining optimal staffing levels for operations.

The staffing capacity measurement focuses on employees' specific skillset or skill level (e.g., RNs, LPNs, CNAs, etc. in nursing) within a department or unit. The Performance Ratio can also be used to evaluate subsets of employees for specialties within a skill, such as Charge Nurses or trauma-certified nurses required to be on duty.

TABLE 3

| | | RN FTEs | | |
|---|---|---|---|---|
| | | FTEs From Budget | | |
| | | Budgeted | Patient | Replacement |
| DEP ID | Department Name | FTEs(A) | Care % | % |
| 502100 | Unit B- Med/Surg | 27.00 | 85% | 15% |
| 504110 | Unit E- Telemetry | 28.69 | 80% | 20% |
| 504113 | Unit G - ICU | 30.60 | 75% | 25% |

| FTEs From Position Control | | | | | Available |
|---|---|---|---|---|---|
| | Patient | | | | Replacement FTEs |
| Filled(B) | Care(C) | Orientation(D) | Leave(E) | Other(F) | AVR(G) |
| 23.40 | 22.95 | 0.00 | 0.00 | 0.00 | 0.45 |
| 22.50 | 22.95 | 1.80 | 0.90 | 0.00 | −3.15 |
| 24.30 | 22.95 | 0.00 | 0.00 | 1.80 | −0.45 |

FTEs From Time and Attendance (date range below
used to calculate Actual FTE by Weed for Ratio)

| Start | End | Indirect(H) | NonProd(I) | ARU(J) | FTE Gap(K) |
|---|---|---|---|---|---|
| Jun. 23, 2024 | Jul. 28, 2024 | 2.10 | 1.97 | 4.07 | −3.62 |
| Jun. 23, 2024 | Jul. 28, 2024 | 1.91 | 1.87 | 3.78 | −6.93 |
| Jun. 23, 2024 | Jul. 28, 2024 | 0.77 | 1.82 | 2.60 | −3.05 |

| FTE Gap/Filled(L) | FTE Gap/Budget(M) | Performance Ratio |
|---|---|---|
| −0.15 | −0.13 | 11 |
| −0.31 | −0.24 | −120 |
| −0.13 | −0.10 | −577 |

### Enhanced Scheduling View

The Performance Ratio provides a fundamental unit of measurement for capacity management and is central to the optimization function.

An Enhanced Scheduling View Dashboard, as illustrated in the table below, leverages the integration between the Enhanced Budget Tool and the Enhanced Position Control.

This provides direct feedback regarding how well a department/unit manages resource allocation to its budget.

By pulling forward onto the dashboard the budgeted allocation of Direct/Indirect/Nonproductive time and the position control allocation of that budget, and the resulting Performance Ratio, a manager can see at a glance how in line each week of the schedule (and by pay period and the entire schedule) is with the budget given the state of their position control.

By comparing the Position Control Performance Ratio to each week's actual or scheduled Performance Ratio, decisions can be made preemptively to adjust indirect and/or nonproductive shifts to move staffing and/or labor costs in a more favorable direction, and/or to alert HR and Finance to additional needs to compensate for any staffing shortfalls.

Features of the Enhanced Scheduling View include, but are not limited to:
Date Effective functionality at the Enhanced Budget Tool, Enhanced Position Control, and Enhanced Scheduling View levels provide for “mode selection”
   Mode Selection Options include, at a minimum, Current, Past and Future:
      Current
         For day-to-day operations
      Past
         For historical reporting
      Future
         For planning not only next year's budget but for “gaming” out scenarios when planning for things like
         Opening a new unit
         Major required educational events for all staff of a certain job/skill

Adding a new product or service to an existing unit or department.

TABLE 4
Budget

| Category | % | FTEs |
|---|---|---|
| Direct | 80.0 | 22.95 |
| Indirect | 10.0 | 2.87 |
| Non productive | 10.0 | 2.87 |
| | 100% | 28.69 |

Position Control

| Category | % | FTEs | | |
|---|---|---|---|---|
| Direct | 89.29 | 22.50 | Available Replacement | −3.25 |
| Indirect | 7.14 | 1.80 | Hr Actual Replacement | −4.23 |
| Non productive | 3.57 | 0.90 | Performance Ratio | −120 |
| | 100% | 25.20 | | |

Performance Ratio legend
Neutral position: Returns 100 when available replacement = actual replacement utilization (ARU)
Variance Condition: Returns >100 when available replacement > ARU
Variance condition: Returns <100 when available replacement < ARU
Variance condition: Returns <0.00 when available replacement is negative, i.e. not enough FTEs to meet baseline patient care needs
Alert condition: Returns null when ARU = 0.00

Thus, the Performance Ratio is a top-line metric that assesses the effectiveness of available resource allocation in supporting Direct time and determining whether available replacement time is being over- or underutilized. The Performance Ratio value is an indicator for leaders to dive deeper into workforce data to determine the root causes of staffing and scheduling issues and labor costs.

In the example illustrated in Table 5 above, the Performance Ratio legend is as follows:
Neutral: returns 100 when available replacement equals actual replacement utilization
Variance Condition: returns>100 when available replacement is greater than actual replacement utilization
Variance Condition: returns<100 when available replacement is less than actual replacement utilization
Variance Condition: returns<0 when available replacement is negative, meaning that there not enough FTEs to meet baseline patient care (end user service) requirement
Alert Condition: Returns Null when ARU=0.00

### Resource Allocation Methodology Data Structure

From Position Control, we can identify the home unit resources available for Direct time. We can calculate a staffing capacity gap by comparing these resources to the FTEs needed for the desired level of care for an expected work volume. FTEs, hours, or shifts can represent the capacity gap to facilitate communication between operations, finance, and human resources.

The data structure is flexible and can be populated with FTEs or hours. It can also evaluate past, current, expected future, and multiple “What if . . . ” scenarios. Core staff direct-time FTE information can also be derived from staffing and scheduling or time and attendance data by aggregating the home staff's straight-time shifts and/or hours.

The structure and aggregation of the data are central to this methodology for evaluating FTE, time and attendance, or staffing and scheduling data. It enables new and innovative workforce data views, ultimately leading to a new performance metric, the Performance Ratio, which describes the effectiveness of allocating available resources for supporting operations.

By evaluating the resource distribution across direct, indirect, and non-productive categories and subcategories, resource allocation can be compared to budgeted (planned) resource distribution.

All employee hours can be aggregated into one of three buckets:
Direct: worked hours that count toward productivity
Indirect: worked hours that do not count toward productivity
Non-Productive: non-worked hours that may be paid or unpaid.

The methodology asserts that all 3 categories of hours support the business and that variances in the data can be used to understand current operational issues and predict future ones.

For example:
Having fewer Direct hours than needed can result in understaffing, increased overtime utilization, contract labor costs, and adverse events.
Fewer Indirect hours than are needed can result in inadequate staff orientation and education, which can lead to quality and safety issues
Underutilization of Non-Productive hours could mean employees are not getting enough time off for rest and recuperation, potentially leading to increased burnout, employee turnover, higher recruitment and retention costs, and/or potential adverse events/errors.

This data structure can be expanded by identifying Direct, Indirect, and Non-Productive time subcategories to give deeper assessments and insights into staffing and scheduling operations. In this particular exemplary embodiment, Direct Time, Indirect Time and Non-Productive categories per job role might include Charge Nurse, RN, LPN, etc., but it will be apparent to a person skilled in the art that different such subcategories could be defined for different businesses.

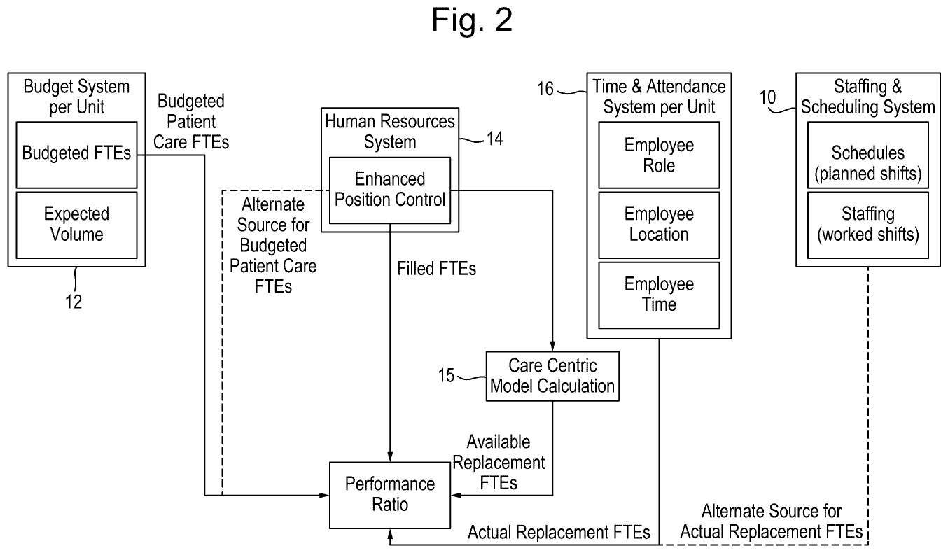

Referring to FIG. 2 of the drawings, a resource allocation system according to an exemplary embodiment of the invention is integrated into a wider management system that comprises a Staffing and Scheduling module 10 incorporated in a resource allocation system comprising a Budget (per unit) module 12, a Human Resources module 14 and a Time & Attendance (per unit) module 16.

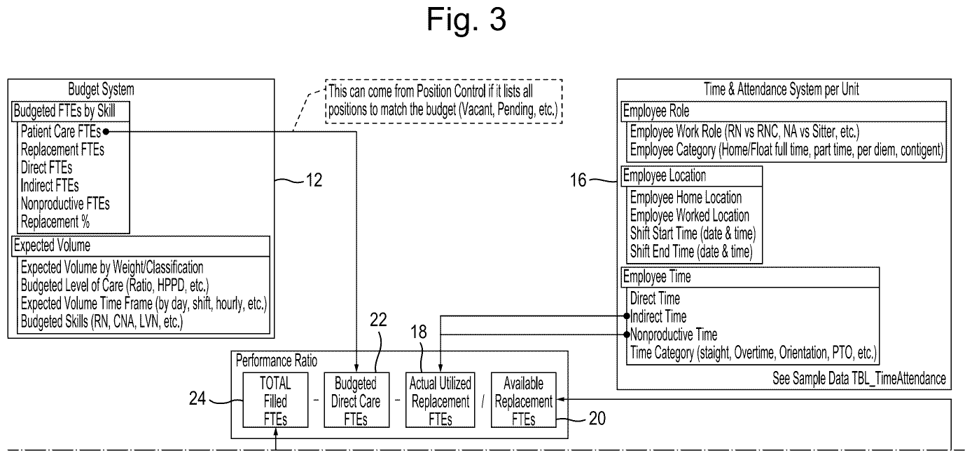

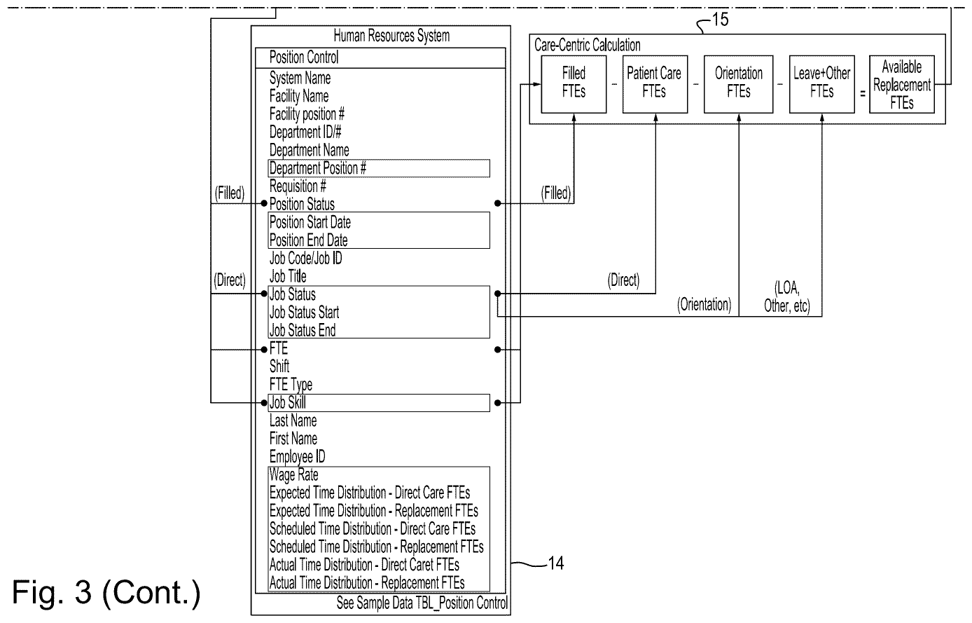

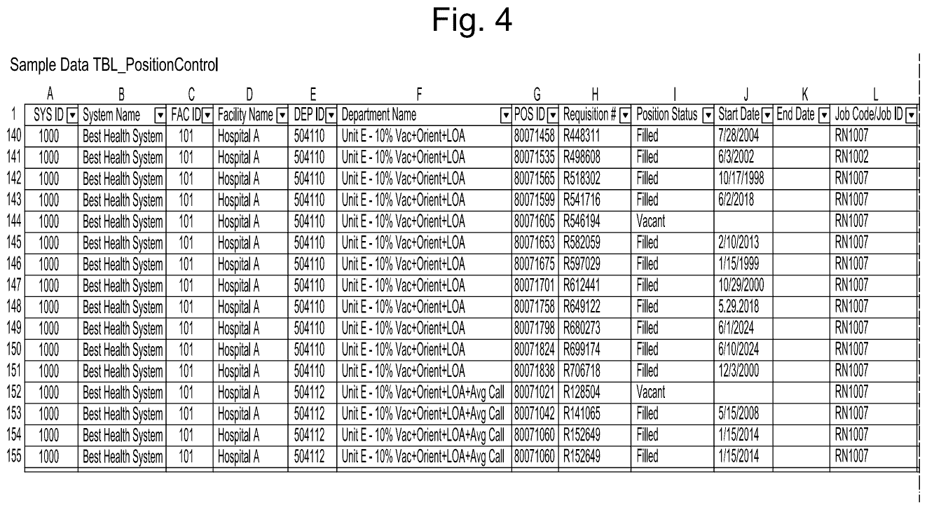

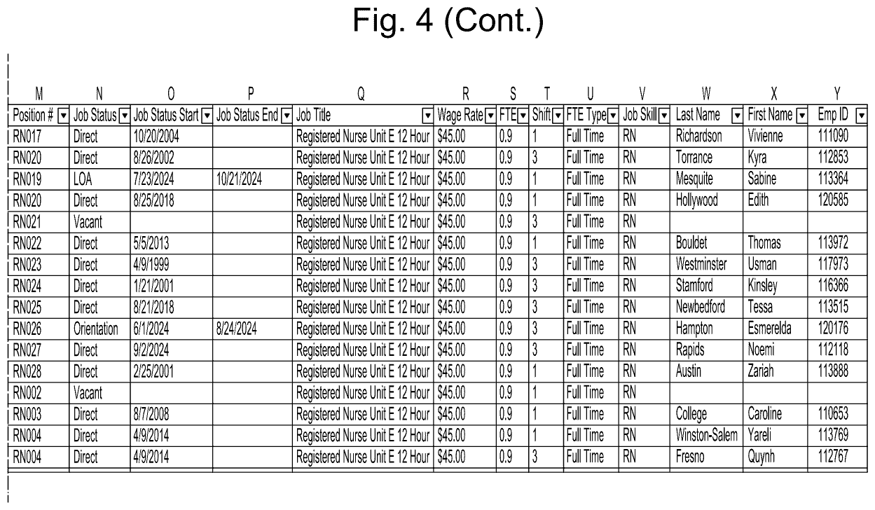

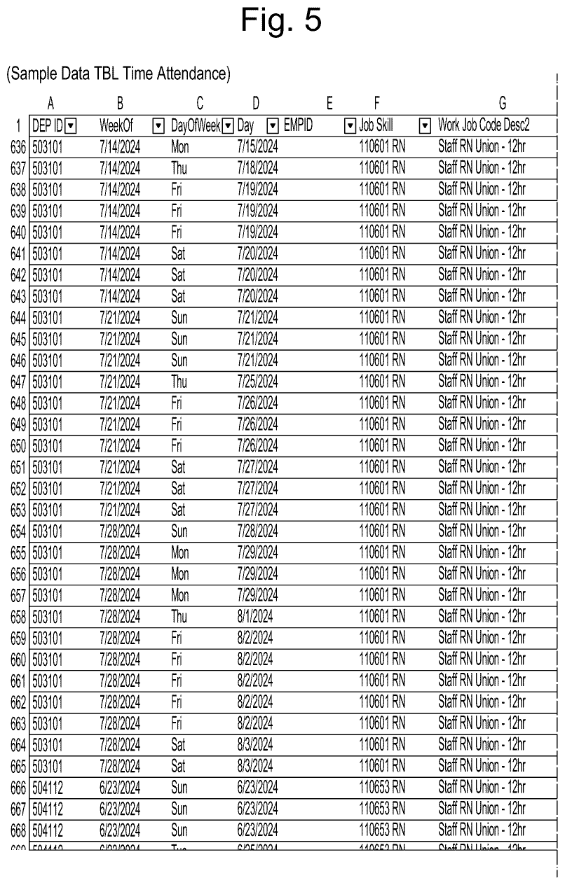

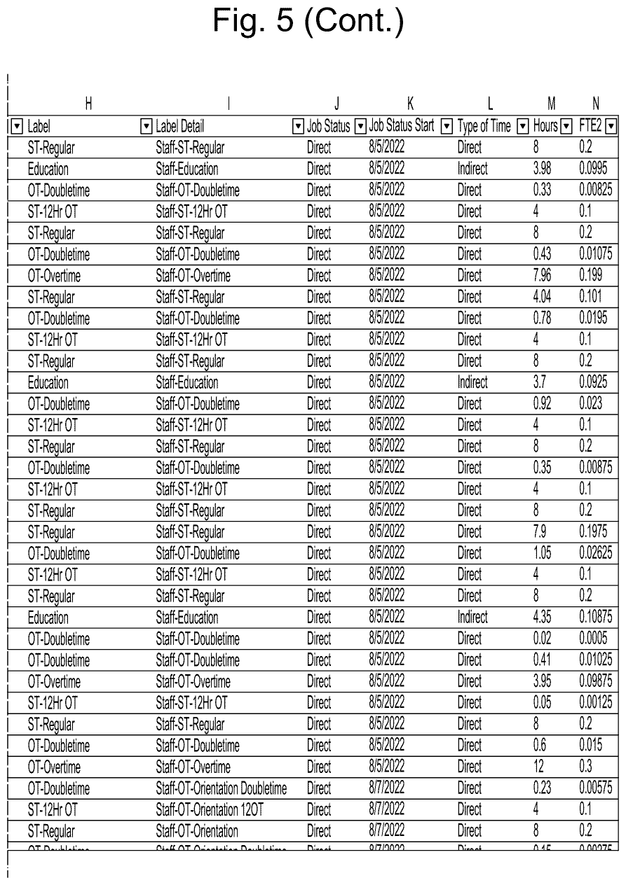

Referring additionally to FIG. 3 of the drawings, the staff data referenced above is obtained from the Time & Attendance module 16, which calculates the Actual Utilized Replacement FTEs 18, as described above but using historical staff data as illustrated in table form in FIG. 5 of the drawings. A care (business)-centric calculation module 15 calculates the available replacement FTEs 20 in respect of the current staff data, as described above. The (current or projected) Budgeted Direct Care FTEs data 22 is obtained from the Budget System 12, and the total filled FTEs data 24 is obtained from the Human resources module 14, using the Position Control data described above and illustrated in table form in FIG. 4 of the drawings.

From Position Control, the system calculates the workforce or team resources available for Direct Time. A staffing capacity gap is calculated by comparing these resources to the FTEs needed for the desired level of care for an expected patient volume (the latter being based on historical data relating to patient volumes). The Capacity Gap can be represented by FTEs, hours or shifts to facilitate communication between nursing operations (in this case), finance and human resources.

The categories and subcategories of Direct Time hours in this exemplary embodiment are illustrated in the table below, which is to be understood to be purely for illustrative purposes:

(Direct Time categories per job role include Charge Nurse, RN, LPN, etc)

TABLE 5

| | | | |
|---|---|---|---|
| Home Staff | Full Time | Straight Time | Direct Time |
| Home Staff | Part-Time | Straight Time | Direct Time |
| Home Staff | Per Diem | Straight Time | Direct Time |
| Home Staff | Per Diem | Premium Overtime | Direct Time |
| Home Staff | Full Time | Straight Time Overtime | Direct Time |
| Home Staff | Part-Time | Straight Time Overtime | Direct Time |
| Home Staff | Full Time | Premium Overtime | Direct Time |
| Home Staff | Part-Time | Premium Overtime | Direct Time |
| Float Staff | Full Time | Straight Time | Direct Time |
| Float Staff | Part-Time | Straight Time | Direct Time |
| Float Staff | Per Diem | Straight Time | Direct Time |
| Float Staff | Full Time | Straight Time Overtime | Direct Time |
| Float Staff | Part-Time | Straight Time Overtime | Direct Time |
| Float Staff | Full Time | Premium Overtime | Direct Time |
| Float Staff | Part-Time | Premium Overtime | Direct Time |
| Contingent Staff | Contract | Straight Time | Direct Time |
| Contingent Staff | Contract | Straight Time Overtime | Direct Time |
| Contingent Staff | Contract | Premium Overtime | Direct Time |
| Contingent Staff | Per Diem | Straight Time | Direct Time |
| Contingent Staff | Per Diem | Straight Time Overtime | Direct Time |
| Contingent Staff | Per Diem | Premium Overtime | Direct Time |

The categories and subcategories of Indirect Time hours in this exemplary embodiment are illustrated in the table below, which is to be understood to be purely for illustrative purposes:

(Indirect Time Categories per job role include Charge Nurse, RN, LPN, etc.)

TABLE 6

| | | | |
|---|---|---|---|
| Home Staff | Full Time | Straight Time | Orientation, Education, Admin Time, etc. |
| Home Staff | Part-Time | Straight Time | Orientation, Education, Admin Time, etc. |
| Home Staff | Per Diem | Straight Time | Orientation, Education, Admin Time, etc. |
| Home Staff | Full Time | Straight Time Overtime | Orientation, Education, Admin Time, etc. |
| Home Staff | Part-Time | Straight Time Overtime | Orientation, Education, Admin Time, etc. |
| Home Staff | Full Time | Premium Overtime | Orientation, Education, Admin Time, etc. |
| Home Staff | Part-Time | Premium Overtime | Orientation, Education, Admin Time, etc. |
| Float Staff | Full Time | Straight Time | Orientation, Education, Admin Time, etc. |
| Float Staff | Part-Time | Straight Time | Orientation, Education, Admin Time, etc. |
| Float Staff | Per Diem | Straight Time | Orientation, Education, Admin Time, etc. |
| Float Staff | Full Time | Straight Time Overtime | Orientation, Education, Admin Time, etc. |
| Float Staff | Part-Time | Straight Time Overtime | Orientation, Education, Admin Time, etc. |
| Float Staff | Full Time | Premium Overtime | Orientation, Education, Admin Time, etc. |
| Float Staff | Part-Time | Premium Overtime | Orientation, Education, Admin Time, etc. |
| Contingent Staff | Contract | Straight Time | Orientation, Education, Admin Time, etc. |
| Contingent Staff | Contract | Straight Time Overtime | Orientation, Education, Admin Time, etc. |
| Contingent Staff | Contract | Premium Overtime | Orientation, Education, Admin Time, etc. |
| Contingent Staff | Per Diem | Straight Time | Orientation, Education, Admin Time, etc. |
| Contingent Staff | Per Diem | Straight Time Overtime | Orientation, Education, Admin Time, etc. |
| Contingent Staff | Per Diem | Premium Overtime | Orientation, Education, Admin Time, etc. |

The categories and subcategories of Non-Productive hours in this exemplary embodiment are illustrated in the table below, which is to be understood to be purely for illustrative purposes:

(Non-Productive Time Categories per job role include Charge Nurse, RN, LPN, etc.)

TABLE 7

| | | | | |
|---|---|---|---|---|
| Home Staff | Full Time | Paid | Scheduled | Sick, Vacation, PTO, Jury Duty, Holiday, etc. |
| Home Staff | Part-Time | Paid | Scheduled | Sick, Vacation, PTO, Jury Duty, Holiday, etc. |
| Home Staff | Per Diem | Paid | Scheduled | Sick, Vacation, PTO, Jury Duty, Holiday, etc. |
| Home Staff | Full Time | Unpaid | Scheduled | Leave Without Pay (LWOP) |
| Home Staff | Part-Time | Unpaid | Scheduled | Leave Without Pay (LWOP) |
| Home Staff | Per Diem | Unpaid | Scheduled | Leave Without Pay (LWOP) |
| Home Staff | Full Time | Paid | Unscheduled | Sick, PTO, etc |
| Home Staff | Part-Time | Paid | Unscheduled | Sick, PTO, etc |
| Home Staff | Per Diem | Paid | Unscheduled | Sick, PTO, etc |
| Home Staff | Full Time | Unpaid | Unscheduled | Leave Without Pay (LWOP) |
| Home Staff | Part-Time | Unpaid | Unscheduled | Leave Without Pay (LWOP) |
| Home Staff | Per Diem | Unpaid | Unscheduled | Leave Without Pay (LWOP) |

If there are specific categories of time not captured by the standard categories, additional sub-categories can be added to the Direct, Indirect and Non-Productive categories. All hours must be allocated to a category.

### Time Category Spread

Aggregating direct time by category type can provide insights into how workforce allocation impacts productivity and costs, as illustrated in the table below. The Direct Time Category Spread analysis aggregates direct time hours by time category:
Home ST: Straight time hours/FTEs by home department employees
Home OT: Overtime hours/FTEs by home department employees
Float ST: Float hours/FTES by home facility employees
Float OT: Overtime float hours/FTEs by home facility employees
Contingent ST: Straight time hours/FTEs by home contingent employees
Contingent OT: Overtime hours/FTEs by home department employees
Contingent Float ST: Float hours/FTES by home contingent employees
Contingent Float OT: Overtime float hours/FTEs by home contingent employees

Additional time categories may be added to the data structure to address operational reporting and data analysis needs

If there are not enough home unit resources to provide the direct care straight time FTEs/Hours for the desired level of patient care for a given patient volume, staffing must be supplemented with the other time categories to achieve the desired level of care.

The distribution of the supplemental hours/FTEs can be used to calculate the difference in labor costs between Home OT, Float ST, Float OT, Contingent ST, Contingent OT, Contingent Float ST, and Contingent Float OT by calculating actual or average wage rates for each category and then multiplying by the number of hours for each category.

Shifting hours/FTEs from the premium OT and Contingent ST/OT categories to the Home ST category can help to decrease labor costs. By identifying the number of hours to be moved to the Home ST category, operational strategies can be implemented, for example, to decrease OT across the Home, Float, Contingent, and Contingent Float categories and/or increase the hours/FTEs in the Home ST category through recruitment and retention efforts.

### Capacity Gap Analysis

By evaluating the allocation of workforce/team straight-time resources in the direct time category, the method is able to determine the patient census that can be supported with these resources. Patient census refers to the number of people currently under the care of a specific healthcare unit. It represents the current number of individuals receiving care at a given time. The average daily census (ADC) is the average number of inpatient stays in a hospital over a designated period.

The actual operational census can be determined and evaluated to determine the FTEs needed to provide care for this patient volume.

The difference between the Operational Census FTEs and the FTEs that can be supported with available straight-time Direct Time resources (available from the Position Control data in the Human Resources module 14) represents the Capacity Gap needed to fill bedside shifts. It will be appreciated that, in this exemplary embodiment at least, Capacity Gap is calculated for individual skills.

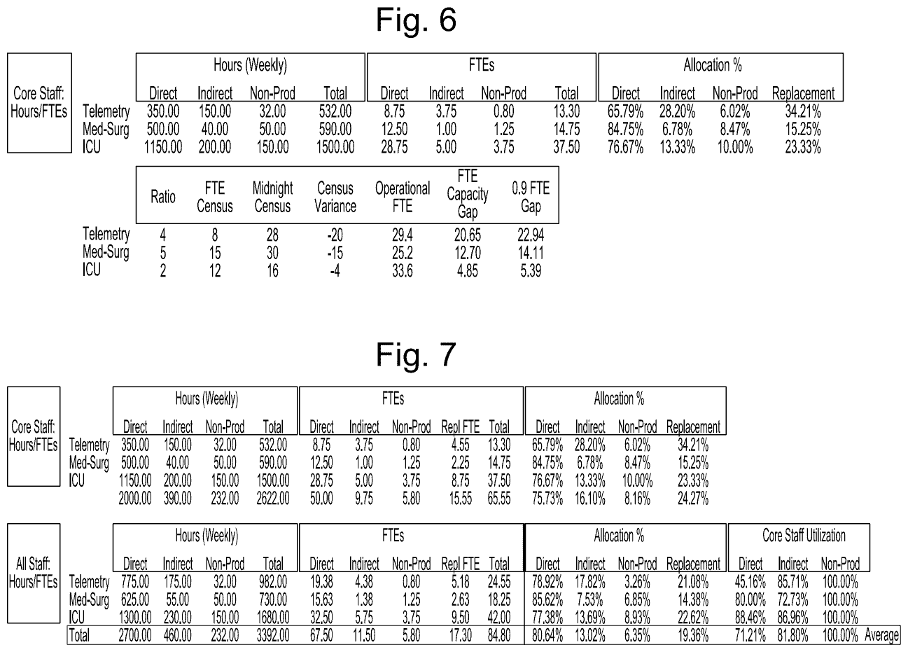

Consider the Capacity Gap data in FIG. 6 of the drawings, provided for illustrative purposes only.

Direct Hours are all workforce/team straight-time (non-overtime) resources in the Direct Time category. Indirect Time hours are all workforce/team straight time indirect hours. Non-Prod hours are all workforce/team non-productive hours.

Hours can be for a single week or a weekly average of a range of weeks, depending on the requirements/preferences of the organisation.

FTEs are calculated by dividing the hours by the appropriate hours per FTE value.

Allocation percentages are calculated by dividing the FTE category by the Total FTEs.
Ratio is the desired nurse-to-patient ratio. This table can be modified to use HPPD or other units of service metrics.
The FTE Census is determined by calculating the number of patients that can be cared for with the available Direct FTEs and a given level of care, which may be defined as HPPD, nurse-to-patient ratio, or any other accepted Units of Service metric.
Midnight Census is obtained from the primary system for capturing patient data. This is often the Electronic Medical Record (EMR). Midnight Census can be replaced by Shift Start Census, Hourly Census, 4-hour block census, etc.—whatever is of most value for operations. This value can also be modified to model different “What if . . . ?” scenarios.
Census Variance=FTE Census−Midnight Census or other reported census, such as Shift Start Census, Hourly Census, 4-hour block Census, etc. This represents the difference in patients that can be cared for with Available Direct FTEs vs actual FTEs needed to care for the specified Operational Census.
Operational FTEs are the resources required to provide care for the Operational Census (Midnight Census, in this example) at the expected level of care (nurse-to-patient ratio, in this example). This may define the ‘care’ objective in the optimization function described hereinafter.
FTE Capacity Gap=Operational FTE-Direct FTEs. This represents the number of additional Direct time FTEs needed to provide care for the Operational Census (Midnight Census, in this example) at the expected level of care (nurse-to-patient ratio, in this example)
0.9 FTE Gap=FTE Capacity Gap/0.9. This is the number of 0.9 positions needed to provide the number of FTEs in the FTE Capacity Gap.

The next step in the Capacity Gap analysis is to calculate Core Staff hours and FTEs as a percentage of Total Hours, as illustrated (purely by way of example) in FIG. 7 of the drawings.

All Staff Hours/FTEs include all overtime, float, and contingent worker hours.

The Core Staff Utilization percentages are calculated by dividing the Core Staff Hours/FTEs by the All Staff Hours/FTEs for the Direct, Indirect, and Non-Productive time categories. This value represents the percentage of total hours paid that were covered by the workforce/team straight time hours.

Since the Direct time category Core Staff Hours/FTEs are all non-premium hours/FTEs, a low utilization percentage would indicate that additional resources, such as overtime, float, and contingent workers, were needed to meet direct care staffing goals. This can have significant implications for labour costs.

The Allocation % and Core Staff Utilization numbers can be used to determine how well resource distribution matches budget assumptions for direct, indirect, and non-productive goals.

With the actual Replacement % calculated, the entire budget can be recalculated to determine the FTEs needed to meet patient care needs, given the actual allocation of resources, as illustrated in the table below:

TABLE 8

| FTEs | Ops total | Filled | Pat care | replacement | Repl % | Vacancy | FVR % |
|---|---|---|---|---|---|---|---|
| Telemetry | 44.69 | 13.30 | 29.40 | 15.29 | 34.21% | 31.39 | 70.24% |
| Med Surg | 29.74 | 14.74 | 25.20 | 4.54 | 15.25% | 14.99 | 50.54% |
| ICU | 37.50 | 37.50 | 33.60 | 10.23 | 23.33% | 6.33 | 14.43% |

Ops Total: Total operational FTEs needed to provide patient care for the actual replacement utilization percentage

$$Ops Total = Pat Care FTEs / ( 1 - Actual Replacement \% from All Staff Hours / FTEs above )$$

Filled: Total filled FTEs from Position Control.
Pat Care: FTEs needed to provide the desired level of patient care for a given patient volume. Value comes from the Budget
Replacement: Calculated replacement FTEs based on FTEs needed for patient care and actual replacement utilization.

$$Ops Total - Pat Care = Replacement$$

Repl %: Actual total Replacement % value from All Staff Hours/FTEs
Vacancy: Vacant FTEs based on recalculated budget FTEs. Ops Total−Filled=Vacancy
Functional Vacancy Rate (FVR %): The vacancy rate is based on the recalculated budgeted FTEs. Represents the total number of FTEs needed to meet the budget goals for direct, indirect, and non-productive time based on actual replacement utilization percentages, actual resource distribution percentages across time categories, and actual patient volume. Vacancy/Ops Total*100=FVR %

Budgeted FTEs can be calculated on the actual replacement utilization rate to determine the Functional Vacancy Rate. Based on the current resource distribution percentages, this table determines the number of FTEs needed to meet desired patient care levels while maintaining the actual replacement rate.

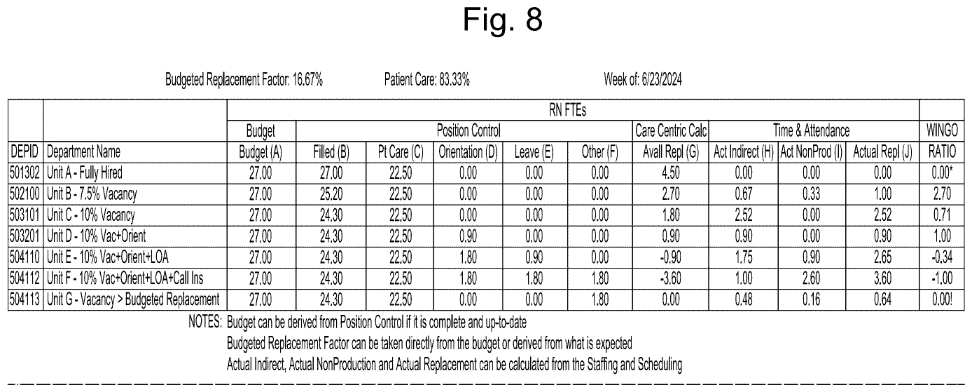

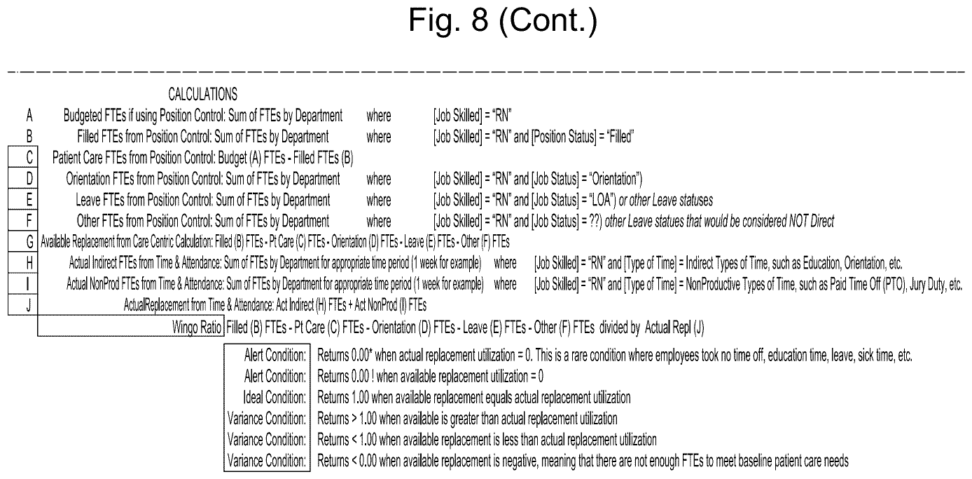

Calculation of the Performance Ratio for measurement of staffing capacity (performance metric) is illustrated (purely by way of example), in FIG. 8 of the drawings, and described in detail above.

Performance Ratio parameters can be calculated based on actual, budgeted, projected, or desired FTE levels to describe current staffing effectiveness or to evaluate how operational changes may impact future staffing scenarios.

For example, if Actual Replacement Utilization is higher than Available Replacement Resources, leaders will know how many FTEs and/or hours need to be reallocated to other parameters in the formula to move the value in the desired direction. They can then dive deeper into the data by using Position Control, Care Centric Modeling formula, Capacity Gap Analysis, Float Hours Matrix, and Time Category Spread data to examine the factors impacting the metric.

Single and multifactor “what if?” scenarios can be analyzed. For example, you can evaluate modifying the FTE utilization for direct care and specific categories within the indirect and non-productive categories, such as orientation and unscheduled absences, to determine how various changes in resource allocation impact staffing capacity.

“Levers” can be pulled to modify the number of FTEs needed to bring the Performance Ratio toward 100, improve staffing, and control labour costs. By understanding how hours and FTEs are allocated across multiple time categories and their subcategories, we can gain insights into how our workforce resources are allocated and how that allocation impacts operations, care delivery, and costs. Understanding how many hours are in each category provides insights, opportunities, and data for strategic discussions on how many hours need to be reallocated to other categories for the desired operational results.

Examples of variables that can be adjusted and their potential impacts:
Utilization of unbudgeted FTEs to supplement and/or replace home unit staff: per diem, staff overtime, float, float overtime, contingent, contingent overtime
   Utilization of unit staff OT, float straight time and OT, contingent worker float, straight time, and OT all represent home staff straight time hours that were unavailable to support staffing needs on the unit. Utilizing these resources can mask the actual severity of the resource problem in the unit. For example, a unit may appear to be “100% productive”, but they achieved that by utilizing a high percentage of home staff overtime, float staff, float staff overtime, and contingent staff and contingent staff overtime. This would put the unit at risk for higher rates of turnover, absenteeism, and burnout, all of which have resource, quality, safety, and financial implications
Direct Time:
   The desired level of patient care can be increased or decreased.
   Skill Mix: RN vs LPN, licensed vs unlicensed staff can be adjusted to impact labor costs.
Indirect Time can be adjusted up or down to address labor costs and/or operational needs.
   Orientation
      Length of orientation needed
   Education
      Scheduling of educational initiatives and the impact on staffing capacity
   Administrative Time
   Support Roles (Charge Nurse, Sitter, etc.)
   Other roles that should not count in productivity
Non-productive time can be more closely monitored and, where possible, managed.
   Scheduled vs Unscheduled time
   PTO
   Sick
   Leave
Employee Turnover
   Retention
   Recruitment
   The data can provide early warning signs for staffing issues that can impact recruitment and retention efforts

Aggregating direct time by category type can provide insights into how workforce allocation impacts productivity and costs. The Direct Time Category Spread analysis aggregates direct time hours by time category:
Home ST: Straight time hours/FTEs by home department employees
Home OT: Overtime hours/FTEs by home department employees
Float ST: Float hours/FTES by home facility employees
Float OT: Overtime float hours/FTEs by home facility employees
Contingent ST: Straight time hours/FTEs by home contingent employees
Contingent OT: Overtime hours/FTEs by home department employees
Contingent Float ST: Float hours/FTES by home contingent employees
Contingent Float OT: Overtime float hours/FTEs by home contingent employees

If there are not enough home unit resources to provide the direct care straight time FTEs/Hours for the desired level of patient care for a given patient volume, staffing must be supplemented with the other time categories to achieve the desired level of care.

The distribution of the supplemental hours/FTEs can be used to calculate the difference in labor costs between Home OT, Float ST, Float OT, Contingent ST, Contingent OT, Contingent Float ST, and Contingent Float OT by calculating actual or average wage rates for each category and then multiplying by the number of hours for each category.

Shifting hours/FTEs from the premium OT and Contingent ST/OT categories to the Home ST category can control labor costs. By identifying the number of hours to be moved to the Home ST category, operational strategies can be implemented, for example, to decrease OT across the Home, Float, Contingent, and Contingent Float categories and/or increase the hours/FTEs in the Home ST category through recruitment and retention efforts.

Leaders can also look to the Care Centric Modeling formula and the Capacity Gap analysis for further insights.

As calculated in the Care Centric Modeling formula, overutilization of Available Replacement Time results in unfilled shifts that must be filled to meet the desired level of patient care.

The Capacity Gap Analysis provides the distribution of hours/FTEs between the Direct, Indirect, and Non-Productive categories. Overutilization of available replacement time for Indirect and Non-Productive time results in a shortage of resources needed for Direct time that may need to be filled with premium dollar labor.

### Float Hours Matrix

The Float Hours Matrix details the number of hours and/or FTEs by skill floated from one unit to another. Float Hours represent unavailable FTE hours for the unit being floated to that were needed to meet operational needs. Float hours can mask the severity of understaffing on a unit, and floating is often a dissatisfies for nursing staff that are floated, which may have implications for turnover and retention.

At a high level, the Float Hours Matrix shows total hours, but the total hours can be broken down into subcategories for additional insights:
Unit-to-unit: Straight Time
Unit-to-unit: Overtime
Float Pool: Straight Time
Float Pool: Overtime
Home Facility Per Diem: Straight Time
Home Facility Per Diem: Overtime
Contingent Per Diem: Straight Time
Contingent Per Diem: Overtime
Contingent Contract: Straight Time
Contingent Contract: Overtime

### Application of Data and Concepts

The preceding concepts, calculations and tools can be utilized in stand-alone dashboards and applications, integrated into workforce management applications, such as existing staffing and scheduling systems, or used to create a new system with resource allocation at its core.

For example, in a staffing and scheduling system, when a manager begins creating their schedule for the next month, the following information displayed on the scheduling screen can provide valuable insight into resource allocation:
The Care-Centric Modeling formula FTE values can be updated in real-time as the manager creates their schedule, assigns staff to direct, indirect, and non-productive shifts, and calculates the available replacement for indirect and non-productive time.
For each week of the schedule screen, the distribution of hours and/or FTES and their corresponding percentages for direct, indirect, and non-productive time and the Performance Ratio guides how effectively the resources have been distributed based on budget and operational goals.
Settings can toggle an additional set of metrics that covers 2-week pay periods or full scheduling periods, where the user defines the weeks per scheduling period.
The Care-Centric Modeling formula can be integrated into a position control tool to assess staffing capacity by incorporating actual replacement FTE utilization from the Capacity Gap Analysis. Deducting actual or desired replacement utilization from filled FTEs will calculate the resources available for direct time (such as patient care).
The Performance Ratio also indicates how much Available Replacement is being over or underutilized. The further away from 100 the Performance Ratio is, the higher the rate of over or underutilization of replacement resources.
The staffing optimization system in this patent application offers several advantages, including:
   a. Improved Operations: Optimal staffing leads to better outcomes, reduced errors, better cost control, and enhanced customer and employee satisfaction.
   b. Enhanced Employee Satisfaction: By providing insights and early warning on resource shortages and their magnitude, the system allows leaders to respond to staffing needs more proactively, promoting job satisfaction, increasing retention and potentially avoiding associated negative effects of understaffing by enhancing employee satisfaction and decreasing turnover and recruitment and retention costs.
   c. Cost Efficiency: The optimized staffing system minimizes unnecessary labor expenses while ensuring adequate staffing levels.
   d. Scalability: While this solution can be adjusted and expanded to different healthcare environments, ranging from small clinics to large hospital networks, the method is not specific to any particular business. It can be used in areas beyond nursing and healthcare for any shift-based work that varies by work volume. The process starts by collecting essential operational data, including position control FTE data, historical volume, budget data, and employee hours from the staffing and scheduling system or time and attendance system.

In conclusion, this invention seeks to provide a novel staffing optimization system and method. Displaying budget and position control data alongside new data calculations and metrics derived from the mathematical interactions between budget, position control, staffing, and scheduling data creates novel and innovative information displays that provide unprecedented visibility for operational factors impacting staffing, scheduling, productivity, and labor costs. In particular, the nurse staffing problem, for example, is a critical challenge that requires innovative solutions to provide quality care, enhance nurse job satisfaction, and optimize operational efficiency in healthcare facilities.

### Optimization and PRN Requests:

### Dynamic and Real-Time Optimization:

The FTE-based nurse staffing solution operates dynamically, continuously assessing staffing needs based on real-time data. It allows for adjustments to the PRN position requests as the week progresses, ensuring staffing levels are continuously optimized to meet patient needs. The core innovation of this provisional patent application lies in the dynamic and real-time nature of the nurse staffing optimization system. By integrating advanced algorithms and machine learning, as well as critical metrics, as described above, that describe the capacity of a unit to react to load variations, the system continually evaluates staffing schedules in real-time to account for changing demands, employee requests, and patient needs. This adaptability ensures that both hard and soft constraints are satisfied, allowing for optimized nurse staffing without compromising employee well-being or patient care.

When a skill level or skill coverage gap is identified in the upcoming week's schedule, the system alerts the staffer/scheduler of the shortfall. The solution provides the staffer/scheduler with the option to request PRN (as-needed) positions to fill these gaps temporarily.

In relation to the staffing capacity, for example, the Performance Ratio described above may be utilized to prioritize schedules that result in a Performance Ratio as close to ‘100’ as possible, in an attempt to balance available budgeted resources with projected patient care needs, utilizing Available Replacement FTEs and Actual Replacement FTEs (e.g. from historical Actual Replacement FTEs) data. Referring to FIG. 8 of the drawings, an example of this is illustrated in Table form, summarizing the fictional data used, and the manner in which each data item is calculated.

It will be appreciated by a person skilled in the art, from the foregoing description, that modifications and variations can be made to the described embodiment without departing from the scope of the invention as defined by the appended claims. In particular, the invention is not necessarily intended to be limited to use in healthcare facilities, as described, but would be readily adaptable for use in other types of organizations.

What is claimed is:

1. A computer-implemented staffing schedule evaluation method performed in a resource allocation system comprising, or communicably coupled to, a Staffing and Scheduling module and/or a Time and Attendance module, a Budget Module and a Position Control module, the method comprising, under control of a processor of said resource allocation system:
collecting, from a Staffing and Scheduling module or a Time and Attendance module, scheduled staff data representative of a specified staffing schedule covering a specified period of time and including Direct staff data representative of the volume of staff scheduled, in the specified staffing schedule, to deliver a core business activity and Inactive staff data representative of the volume of staff included in the specified staffing schedule as not delivering the core business activity;
transforming the Inactive staff data from the scheduled staff data into a normalized Actual Replacement data set representative of the Inactive staff data;
collecting, from a Position control module, Position data representative of a total volume of staff potentially available, during the specified period of time, to deliver the core business activity, and a subset of the total volume representative of staff not actually available, during the specified period of time, to deliver the core business activity;
collecting, from a Budget module, Budget data representative of a required volume of staff to deliver the core business activity to a specified service level for a given volume of core business;
transforming the Position data and the Budget data into respective normalized data sets;
calculating an Available Replacement data set using the Position data and the Budget data;
determining, using the Actual Replacement data set and the Available Replacement data set, Capacity Gap data;
determining a Performance Ratio representative of a relationship between the Capacity Gap data and the Budget data and/or the Position data; and
comparing the Performance Ratio with a predetermined value or threshold to generate evaluation data in respect of the specified staffing schedule.

2. A computer-implemented staffing schedule evaluation method according to claim 1, wherein the Staff data and/or Position data representative of staff not actually available, during the specified period of time, to deliver the core business activity comprises two or more subcategories indicative of a cause of a lack of availability of staff.

3. A computer-implemented staffing schedule evaluation method according to claim 2, wherein the subcategories include Indirect hours representative of hours scheduled for work not contributing to the core business activity and Nonproductive hours representative of hours, paid or unpaid, but not worked.

4. A computer-implemented staffing schedule evaluation method according to claim 1, further comprising displaying, on a user interface, scheduling data comprising the Budget data, the Position data, the Available Replacement data, the scheduled staff data, and the Performance Ratio.

5. A computer-implemented staffing schedule evaluation method according to claim 1, further comprising allowing a user, via the user interface, to alter one or more of the Budget data, the scheduled staff data and the Position data, and recalculating the Performance Ratio using the altered data.

6. A computer-implemented staffing schedule evaluation method according to claim 1, further comprising generating a float hours matrix representative of a normalized data set of staff hours floated from one team to another.

7. A computer-implemented staffing schedule evaluation method according to claim 1, further comprising generating optimized Budget data by:
receiving, from a user, a staffing metric representative of a desired level of end user service;
receiving weighted Unit of Service data representative of a volume of end users required to receive the level of end user service; and
calculating, using the staffing metric and weighted Unit of Service data, Direct staff data representative of a volume of staff required to deliver the desired level of end user service.

8. A computer-implemented staffing schedule evaluation method according to claim 1, in a resource allocation system incorporating a Position Control module, further comprising:
receiving, in the Position Control module, Position Control data representative of position statuses, job statuses, job status change dates and expected or actual Direct, Indirect and Nonproductive time distribution for each filled position; and
calculating, in near real-time or real-time, staffing capacity data using the Position control data.

9. A computer-implemented staffing schedule evaluation method according to claim 8, further comprising:
obtaining Budget data from a Budget module; and
calculating Actual Replacement data and/or Capacity Gap data utilizing the Position Control data and the Budget data.

10. A computer-implemented staffing schedule evaluation system for a resource allocation system, the staffing schedule evaluation system comprising a processor and a memory and being configured, under control of the processor, to execute instructions stored in the memory to perform the staffing schedule evaluation method of claim 1.
